(19) United States
(12) Patent Application Publication
(10) Pub. No.: US 2022/0272897 A1
(43) Pub. Date: Sep. 1, 2022

(54) CUTTING ASSEMBLY AND LAWN MOWER

(71) Applicant: Positec Power Tools (Suzhou) Co., Ltd., Suzhou (CN)

(72) Inventors: Shiping JIAO, Suzhou (CN); Xiahong ZHA, Suzhou (CN); Fengli ZHAO, Suzhou (CN); Changhua LIU, Suzhou (CN)

(21) Appl. No.: 17/636,019

(22) PCT Filed: Aug. 20, 2020
(86) PCT No.: PCT/CN2020/110295

§ 371 Date: Apr. 28, 2022

(30) Foreign Application Priority Data
Aug. 20, 2019 (CN) 2019 10767209.3
Aug. 20, 2019 (CN) 2019 21349270.8

(51) Int. Cl. A01D 34/835; A01D 34/64; A01D 34/73

(52) U.S. Cl. CPC A01D 34/8355; A01D 34/64; A01D 34/733; A01D 34/008

(57) ABSTRACT

A cutting assembly is mounted on the lawn mower to perform cutting work. The cutting assembly includes a cutting deck and at least two cutting element groups disposed at different heights of the cutting deck. Each cutting element group includes at least one cutting element. The cutting deck responds to driving of the lawn mower to rotate and drive the cutting elements to rotate, to form at least two cutting trajectories at the different heights of the cutting deck. In the cutting assembly and the lawn mower, the at least two cutting element groups are disposed at the different heights of the cutting deck, to enable the cutting assembly to be driven by an electric tool to form the at least two cutting trajectories.

This application is a National Stage Application of International Application No. PCT/CN2020/110295, filed on Aug. 20, 2020, which claims benefit of and priority to Chinese Patent Application No. 201910767209.3, filed on Aug. 20, 2019 and Chinese Patent Application No. 201921349270.8, filed on Aug. 20, 2019, all of which are hereby incorporated by reference in their entirety for all purposes as if fully set forth herein.

### TECHNICAL FIELD

The present disclosure, including embodiments of the invention, relates to a cutting assembly and a lawn mower, belonging to garden tools.

### BACKGROUND

An ordinary power lawn mower usually uses a middle portion of the cutting blades disposed on the same layer is a connecting portion, which is connected to a cutting deck by a connecting member. An output shaft of the power lawn mower drives the cutting deck to rotate to mow a lawn. However, when the blade cuts long grass, the cut grass remains in large pieces, and stems left on the lawn are excessively long.

### SUMMARY

An objective of the present disclosure is to provide a cutting assembly and a lawn mower, so that long grass can be cut repeatedly into smaller pieces.

To achieve the foregoing objective, the embodiments of the present disclosure provide the following technical solutions: A lawn mower includes:

a housing;

a cutting assembly, mounted at the housing, and performing cutting work; and

a driving apparatus, including a motor and an output shaft, connected to the cutting assembly, and driving the cutting assembly to perform cutting work, where

the cutting assembly includes a cutting deck and at least two cutting element groups, the cutting deck is connected to the output shaft, cutting element groups of the at least two cutting element groups are respectively located at different heights of the output shaft, the cutting deck responds to driving of the driving apparatus to drive the at least two cutting element groups to rotate to form at least two cutting trajectories, and in different cutting trajectories, the distance between the cutting element group and a center point of the output shaft is not equal.

In some embodiments, the cutting trajectories are circles, a diameter of the cutting trajectory of the cutting element group located above is greater than a diameter of the cutting trajectory of the cutting element group located below of two adjacent cutting element groups, and the at least two cutting element groups are disposed layer by layer from the top to the bottom in a height direction of the cutting deck.

In a some embodiments, a radius difference between the cutting trajectories formed by the adjacent cutting element groups is less than or equal to 20 mm.

In some embodiments, each cutting element group includes at least one cutting element, and the at least one cutting element is evenly distributed in the circumferential direction of the cutting deck.

In some embodiments, a length by which the cutting element protrudes from the cutting deck is greater than or equal to 8 mm.

In some embodiments, the cutting elements within each cutting element group are distributed in a staggered manner in the circumferential direction of the cutting deck.

In some embodiments, a spacing between the two adjacent cutting element groups is between 10 mm and 20 mm.

In some embodiments, a diameter of the cutting deck is less than or equal to 250 mm.

In some embodiments, mounting portions are disposed on the cutting deck, the mounting portions are used to fix the cutting element groups, and the mounting portions are located on an upper surface and a lower surface of the cutting deck.

In some embodiments, the cutting element groups are rotatably disposed on the mounting portions by connecting members.

Some embodiments further provide the following technical solution: A cutting assembly includes a cutting deck and at least two cutting element groups, cutting element groups of the at least two cutting element groups are respectively located at different heights of the cutting deck, the cutting deck responds to driving of the driving apparatus to drive the at least two cutting element groups to rotate to form at least two cutting trajectories, and in different cutting trajectories, the distance between the cutting element group and a center point of the cutting deck is not equal.

Some embodiments further provide the following technical solution: A lawn mower walks and/or works in a working area defined by a boundary, and includes:

a housing;

a movement apparatus, supporting the housing, and used to drive the lawn mower to move;

a cutting assembly, mounted at the housing, and performing cutting work;

a driving apparatus, including a motor and an output shaft, connected to the cutting assembly, and driving the cutting assembly to perform cutting work; and

a control apparatus, electrically connected to the movement apparatus, the cutting assembly, and the driving apparatus, and used to control the driving apparatus to drive the lawn mower to walk and/or work automatically, where

the cutting assembly includes a cutting deck and at least two cutting element groups, the cutting deck is connected to the output shaft, cutting element groups of the at least two cutting element groups are respectively located at different heights of the output shaft, the cutting deck responds to driving of the driving apparatus to drive the at least two cutting element groups to rotate to form at least two cutting trajectories, and in different cutting trajectories, the distance between the cutting element groups and a center point of the output shaft is not equal.

The embodiments of the present disclosure further provide the following technical solution: A cutting assembly is used to be mounted on the lawn mower to perform cutting work. The cutting assembly includes a cutting deck and at least two cutting element groups disposed at different heights of the cutting deck. Each cutting element group includes at least one cutting element. The cutting deck responds to driving of the lawn mower to rotate and drive the cutting elements to rotate, to form at least two cutting trajectories at the different heights of the cutting deck.

Further, in a height direction of the cutting deck, the at least two cutting elements are arranged layer by layer at a top or a bottom of the cutting deck or at a top and a bottom.

Further, the cutting trajectories are circles, and a diameter of the cutting trajectory of the cutting element group located above is greater than a diameter of the cutting trajectory of the cutting element group located below of two adjacent cutting element groups.

Further, a center of circle of each cutting trajectory is located at a vertical central axis of the cutting deck.

Further, the cutting trajectories of the cutting element groups are circles, which gradually decrease in size from the top to the bottom.

Further, the cutting trajectories of all the cutting element groups have the same tangent, and an angle is formed between the tangent and the vertical central axis.

Further, the angle between the tangent and the vertical central axis is greater than or equal to 0 degrees and less than 90 degrees.

Further, in a height direction of the cutting deck, a spacing between the two adjacent cutting element groups is between 10 mm and 20 mm.

Further, all the cutting elements in the at least one cutting element group are mounted on an upper surface or a lower surface by connecting members.

Further, a plurality of mounting portions used to fix the cutting elements are further disposed on the cutting deck, the mounting portions are disposed facing upward from the upper surface, and/or the mounting portions are disposed facing downward from the lower surface.

Further, the cutting element is fixed on the mounting portion by a connecting member, and there is a gap between the cutting element and the mounting portion.

Further, the cutting element is a metal wire.

Further, the cutting element is a blade, the blade includes a base portion and a blade edge, and the blade edge is at least partially disposed on a periphery of the base portion.

Further, the blade is a straight blade, and blade edges are disposed on both sides of the blade.

Further, a plurality of blades is disposed in each cutting element group, and the blades are evenly disposed in a circumferential direction of a vertical central axis of the cutting deck.

Some embodiments further relate to a lawn mower, including:

a housing;

a movement apparatus, driving the lawn mower to move on a lawn;

a cutting assembly, accommodated in the housing, and performing cutting work; and

a driving apparatus, connected to the cutting assembly, and driving the cutting assembly to operate.

Compared with the prior art, Some embodiments have beneficial effects as follows: In the cutting assembly and the lawn mower of the embodiments, the at least two cutting element groups are disposed at the different heights of the cutting deck, to enable the cutting assembly to be driven by the lawn mower to form the at least two cutting trajectories, and the cutting trajectories are distributed at the different heights of the cutting deck, so that long grass is cut repeatedly into smaller pieces.

The foregoing description is merely an overview of the technical solutions of the embodiments of the present disclosure. To understand the technical solutions of the embodiments of the present disclosure more clearly, implementation can be performed according to the content of the specification. A description is provided below in detail by using some embodiments of the present disclosure and with reference to the accompanying drawings.

### BRIEF DESCRIPTION OF THE DRAWINGS

FIG. 1 and FIG. 2 are schematic structural diagrams of a cutting assembly in different directions according to some embodiments;

FIG. 3 is a schematic structural diagram of a cutting element in a cutting assembly according to some embodiments;

FIG. 4 is a schematic structural diagram of an automatic lawn mower according to some embodiments; and

FIG. 5 is a schematic structural diagram of a cutting assembly in different directions according to some embodiments.

### DETAILED DESCRIPTION

The following further describes specific implementations of the present disclosure in detail with reference to the accompanying drawings and the embodiments. The following embodiments are used to describe the present disclosure, but are not intended to limit the scope of the present disclosure.

It should be noted that the terms such as “top”, “bottom”, “left”, “right”, “inside”, and “outside” in the present disclosure are only used to describe the present disclosure with reference to the accompanying drawings but are not used as limiting terms.

A cutting assembly of some embodiments include a cutting deck and at least two cutting element groups distributed in a circumferential direction at different heights of the cutting deck. An electric tool (for example, a lawn mower, including an autonomous lawn mower or a hand-propelled lawn mower) drives the cutting deck to rotate to drive the cutting element groups on the cutting deck to rotate to form at least two cutting trajectories. In different cutting trajectories, the distance between the cutting element groups and a center point of the cutting deck is not equal. The cutting element groups are disposed at the different heights of the cutting deck, so that as the lawn mower walks, the plurality of cutting element groups can cut grass repeatedly at different heights into sufficiently small pieces.

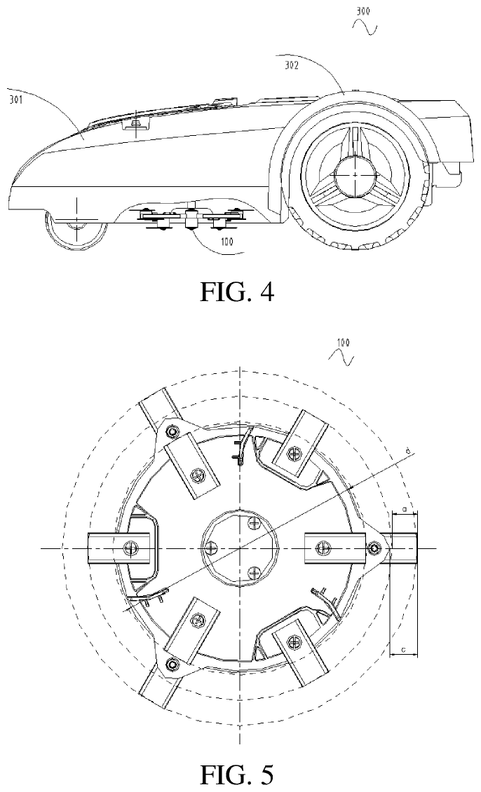

As shown in FIG. 4, an autonomous lawn mower 300 may include: a housing 301; a movement apparatus 302, supporting the housing, and used to drive the lawn mower to move; a cutting assembly 100, mounted on the housing, and used to perform cutting work; a driving apparatus (not shown), including a motor and an output shaft, connected to the cutting assembly, and driving the cutting assembly to perform cutting work; and a control apparatus, electrically connected to the movement apparatus 302, the cutting assembly 100, and the driving apparatus, and used to control the driving apparatus to drive the lawn mower to walk and/or work automatically. In an embodiment of the present application, the autonomous lawn mower may walk and/or work in a working area defined by a boundary. When battery power is low, the autonomous lawn mower may automatically return to a charging station in the working area for charging. The cutting assembly is mainly described in detail in the embodiments of the present application.

In an embodiment of the present application, the cutting assembly may be mounted on the autonomous lawn mower, and may include a cutting deck and at least two cutting element groups distributed in a circumferential direction at the cutting deck. The cutting deck is connected to the output shaft of the motor. Cutting element groups of the at least two cutting element groups are respectively located at different heights of the output shaft. The cutting deck responds to driving of the driving apparatus to drive the at least two cutting element groups to rotate to form at least two cutting trajectories. In different cutting trajectories, the distance between the cutting element group and a center point of the output shaft is not equal. The cutting element groups are disposed at different heights of the output shaft, so that during normal working of the lawn mower, the cutting assembly can cut grass at the same position repeatedly into sufficiently small pieces.

In an embodiment of the present application, the at least two cutting element groups are disposed layer by layer from a top to a bottom in a height direction of the cutting deck. The cutting trajectories formed by the rotation of the cutting element groups are circles. A diameter of the cutting trajectory of the cutting element group located above is greater than a diameter of the cutting trajectory of the cutting element group located below of two adjacent cutting element groups. In this embodiment, as the lawn mower walks, the cutting element group located above touches grass first to cut the grass, and then the cutting element group located below touches the grass again to perform cutting, to implement repeated cutting of the grass at the same position.

In this embodiment, a radius difference between the cutting trajectories formed by the adjacent cutting element groups is less than or equal to 20 mm. By controlling the radius difference between two adjacent cutting element groups, the space occupied by cutting assembly on the lawn mower can be reduced, and the power consumption of the lawn mower can also be reduced.

In this embodiment, each cutting element group includes at least one cutting element. The at least one cutting element is evenly distributed in the circumferential direction of the cutting deck. The cutting elements are evenly disposed in the circumferential direction, so that the balance of the cutting element groups during working can be ensured. Further, a length by which the cutting element protrudes from the cutting deck is greater than or equal to 8 mm. The cutting element with this length can ensure that it is prevented from injuring animals or pedestrians while cutting the grass thoroughly.

In this embodiment, the cutting elements within each cutting element group are distributed in a staggered manner in the circumferential direction of the cutting deck. That is, phases of a plurality of cutting elements in the cutting element groups are different from each other. Specifically, if the plurality of cutting elements in the cutting element groups are separately projected onto a plane perpendicular to the output shaft of the motor. The projections of the plurality of cutting elements do not overlap with each other, and extension lines of the projections of the plurality of cutting elements do not overlap with each other. Alternatively, when the cutting element is a blade, after the blade is projected onto the plane perpendicular to the output shaft of the motor, a nonlinear projection may usually be obtained. In this case, although the cutting elements are distributed in a staggered manner in the circumferential direction of the cutting deck, because a projection of the cutting deck is nonlinear, the plurality of projections may partially overlap. The cutting elements are distributed in a staggered manner in the circumferential direction of the cutting deck, so that as the lawn mower walks, when the cutting element located above finishes cutting grass, the cutting element located below immediately performs secondary cutting on grass at the same position, thereby making maximum use of the cutting assembly in the lawn mower. In other embodiments of the present application, when the cutting elements in the cutting element groups at different heights are arranged in the circumferential direction of the cutting deck, cutting element groups at some heights may overlap. That is, some cutting elements have the same phase or all the cutting elements overlap. The overlap may be that extension lines of the projections of the blades onto the plane perpendicular to the output shaft of the motor are on the same straight line. Alternatively, when there are three or more layers of cutting element groups, two layers of cutting elements may have the same phase. This is not limited in the present application.

In this embodiment, the cutting deck is driven by the electric tool (the lawn mower) to rotate and drive the cutting elements on the cutting deck to operate. The cutting deck is a disk-shaped member, and preferably has a circular shape. A circular cutting deck rotates stably for even mass distribution of the cutting deck. Certainly, the cutting deck may have a triangular shape, a rectangular shape or the like according to an actual requirement. The cutting deck includes an upper surface close to the electric tool and a lower surface opposite to the upper surface. It is defined that a side of the upper surface is the top, and a side of the lower surface is the bottom. The cutting element groups are disposed layer by layer from the top to the bottom in the height direction of the cutting deck, or may be disposed on one same side (disposed together on the top or bottom) of the cutting deck. Generally, the cutting elements rotate with the cutting deck. The formed cutting trajectories are circles. To ensure repeated cutting during cutting of long grass, in the height direction of the cutting deck, a diameter of the cutting trajectory located above is greater than or equal to a diameter of the cutting trajectory located below. Preferably, from the top to the bottom, the cutting trajectories gradually decrease in size, and the cutting trajectories of all the cutting element groups have the same tangent. An angle between the tangent and a vertical central axis of the cutting deck is between 0 degrees and 90 degrees, so that long grass is gradually cut from top to bottom into smaller pieces.

In an embodiment of the present application, a diameter of the cutting deck is less than or equal to 250 mm. Compared with a lawn mower with a relatively large cutting deck, the diameter of the cutting deck is controlled, so that while the cutting deck meets normal grass cutting work of the lawn mower, it is ensured that the lawn mower can use relatively low power consumption to drive the cutting deck to rotate. Further, the diameter of the cutting deck is controlled to prevent the cutting deck from pressing grass during the working of the lawn mower.

In some embodiments, to ensure that the assembly has a simple overall structure and lower manufacturing costs, a center of circle of each cutting trajectory is preferably located on the vertical central axis of the cutting deck. Certainly, without considering manufacturing costs, it may be set that the center of circle deviates from the vertical central axis. In addition, while it is ensured that long grass can be cut into sufficiently small pieces, to avoid a case that adjacent cutting element groups are excessively close to each other and as a result are prone to collision to cause damage, in the height direction of the cutting deck, a spacing between the adjacent cutting element groups is preferably between 10 mm and 20 mm.

Generally, at least one cutting element group is disposed on the upper surface or the lower surface of the cutting deck. The cutting element in the cutting element group is fixed on the cutting deck by a connecting member. In some embodiments, a plurality of mounting portions used to fix the cutting elements are further disposed on the cutting deck, and are disposed between two adjacent cutting element groups. The mounting portions are disposed facing upward from the upper surface of the cutting deck and disposed facing downward from the lower surface of the cutting deck. A plurality of cutting element groups are separately mounted in a staggered manner on the upper surface or the lower surface of the cutting deck, so that a mounting space of the plurality of cutting element groups can be reduced, and mounting costs can be reduced. Certainly, the plurality of cutting element groups may all be mounted on the upper surface of the cutting deck or all be mounted on the lower surface of the cutting deck, which may be specifically chosen according to the positions of cutting elements. This is not limited in the present application. The mounting portion may be independently connected to the cutting deck or integrally formed with the cutting deck. The cutting element is fixed on the mounting portion by a connecting member. Preferably, the connecting member is a screw. A threaded hole fitting the screw is provided in the mounting portion, and there is a gap between the cutting element and the mounting portion. With the screw, each element can be connected and fixed on the mounting portion at low costs. Certainly, without considering costs, the cutting element may be fixed by another connecting member. The gap is provided between the cutting element and the mounting portion, so that when the cutting deck is driven by the electric tool to rotate, the cutting element rotates in the gap, thereby improving the cutting effect of the cutting element.

In some embodiments, the structure of the cutting element belongs to the prior art in the industry, and specifically, may be a metal element such as a blade or a metal wire or a nonmetal element. Preferably, the cutting element is a blade, and includes a base portion and a blade edge. The blade edge is at least partially disposed on a periphery of the base portion. Each blade independently has a regular shape or an irregular shape, or may have a circular shape, a rectangular shape or another shape. Preferably, the blade is a straight blade, and blade edges are disposed on both sides of the blade.

In some embodiments, in a single cutting element group, a quantity of cutting elements is preferably 3. The three cutting elements are evenly disposed at equal intervals in the circumferential direction of the vertical central axis of the cutting deck, to reach a balance between the cutting capability and the load of the electric tool, thereby implementing higher cutting efficiency. Certainly, the quantity of the cutting elements is not limited thereto, and may be set according to an actual requirement.

In some embodiments, preferably, three cutting element groups are disposed, and the three cutting element groups are sequentially disposed at an upper position, a middle position, and a lower position of the cutting deck. That is, one conventional cutting element group mounted in the plane of the cutting deck is kept, and one cutting element group is separately added at the top and the bottom of the cutting deck. Certainly, the quantity of the cutting element groups is not limited thereto, and may be set according to an actual requirement.

The cutting assembly of some embodiments are preferably mounted on the lawn mower, or certainly may be used on another electric tool. The lawn mower mainly includes a housing used for accommodation and protection, a movement apparatus for movement, the foregoing cutting assembly for cutting, and a driving apparatus connected to the cutting assembly and driving the cutting assembly to operate. The driving apparatus is mounted in the housing. The driving apparatus is provided with a motor and an output shaft connecting the motor and the cutting deck, and is used to drive the cutting deck to rotate. The cutting deck rotates to drive the cutting elements to rotate to mow a lawn. Other structures of the lawn mower belong to mature technologies in the field, and details are not described herein again.

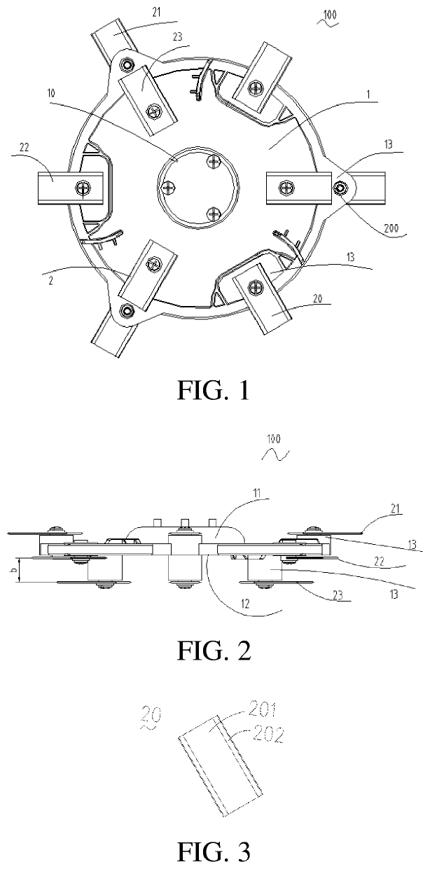

FIG. 1 is a bottom view of the cutting assembly mounted on the autonomous lawn mower shown in FIG. 4. FIG. 2 is a side view of the cutting assembly shown in FIG. 1. The cutting assembly in the embodiments of the disclosure include a cutting deck 1 and three cutting element groups 2 disposed at different heights of the cutting deck 1. As shown in FIG. 2, the three cutting element groups 2 are the first cutting element group 21 disposed at a top of the cutting deck 1, the second cutting element group 22 in a plane of the cutting deck 1, and the third cutting element group 23 disposed at a bottom of the cutting deck 1. Three cutting elements 20 are disposed in each cutting element group 2. The three cutting elements 20 are evenly disposed at equal intervals in a circumferential direction of a vertical central axis of the cutting deck 1. That is, the first cutting element group 21, the second cutting element group 22, and the third cutting element group 23 are concentric circles with different diameters, and the center of circles are located on the vertical central axis of the cutting deck 1. The cutting elements 20 are evenly disposed in the circumferential direction, to reach a balance between the cutting capability and the load of the electric tool, thereby implementing higher cutting efficiency. Certainly, in another embodiment, a quantity of the cutting element groups 2 and a quantity of the cutting elements 20 may be selected according to an actual case.

A fitting surface 10 for joining an output shaft (not shown) of a motor, an upper surface 11 close to the output shaft, and a lower surface 12 opposite to the upper surface 11 are disposed on the cutting deck 1. The fitting surface 10 is provided with a plurality of fitting holes (not shown). In this embodiment, screws are disposed in the fitting holes to fix the cutting deck 1 on the output shaft. Certainly, in another embodiment, a part such as a bolt or a rivet or another fitting structure may be used to connect the cutting deck 1 and the output shaft. The motor drives the cutting deck 1 through the output shaft to rotate and drive the cutting elements 20 to rotate, to enable the cutting element groups 2 to separately from cutting trajectories at different heights of the cutting deck 1, and because the cutting elements 20 rotate along with the cutting deck 1, the cutting trajectory formed by each cutting element group 2 is a circle.

In this embodiment, the three cutting element groups 2 are disposed layer by layer from the top to the bottom in the height direction of the cutting deck 1, and are distributed in a stepped tower form. That is, in a height direction of the output shaft, a diameter of the cutting trajectory located above is greater than a diameter of the cutting trajectory located below. As shown in FIG. 5, a diameter d of the cutting deck is less than or equal to 250 mm. A radius difference a between the cutting trajectories formed by the two adjacent cutting element groups is less than or equal to 20 mm. Because the cutting trajectory located above has a larger size, as the lawn mower shown in FIG. 4 is used to cut grass, the first cutting element group 21 located at the top touches grass first to cut an upper end of the grass; the second cutting element group 22 located in the plane of the cutting deck 1 subsequently cuts the grass; and the third cutting element group 23 located at the bottom cuts a portion of the grass close to the ground, thereby ensuring that long grass is cut into smaller pieces. In addition, while it is ensured that long grass can be cut into sufficiently small pieces, to avoid a case that two adjacent cutting element groups 2 are excessively close to each other and as a result are prone to collision to cause damage, in the height direction of the cutting deck 1, as shown in FIG. 2, a spacing b between the adjacent cutting element groups 2 is between 10 mm and 20 mm.

In this embodiment, mounting portions 13 used to fix the cutting elements 20 are further disposed on the cutting deck 1, and are separately used to fix the cutting elements 20 in the first cutting element group 21 and the third cutting element group 23. As shown in FIG. 1, when the cutting elements in the cutting element groups are distributed in a staggered manner in the circumferential direction of the cutting deck, it may be that the first cutting element group 21 and the third cutting element group 23 have the same phase different from the phase of the second cutting element group. A length c by which the cutting element protrudes from the cutting deck is greater than or equal to 8 mm. Specifically, the mounting portions 13 used to mount the cutting elements 20 in the first cutting element group 21 are disposed protruding upward from the upper surface 11, the second cutting element group 22 is mounted on the lower surface 12 of the cutting deck 1, and mounting portions 13 used to mount the cutting elements 20 in the third cutting element group 23 are disposed protruding downward from the lower surface 12. In this embodiment, the mounting portions 13 and the cutting deck 1 are integrally formed, and certainly may be separately mounted in another embodiment. A mounting hole (not shown) is provided in the mounting portion 13. In this embodiment, the cutting element 20 is fixed at the mounting portion 13 by a connecting member 200. The connecting member 200 in this embodiment is a screw. Certainly, in another embodiment, a part such as a bolt or a rivet or another fitting structure may be used to connect the cutting element 20 and the mounting portion. The gap is provided between the cutting element 20 and the mounting portion 13, so that when the cutting deck 1 is driven by the electric tool to rotate, the cutting element 20 rotates in the gap, thereby improving the cutting effect of the cutting element.

With reference to FIG. 3, the cutting element 20 in this embodiment is a straight blade of a rectangular shape, and includes a base portion 201 and a blade edge 202. The blade edge 202 is disposed on a periphery of the base portion 201. Certainly, in another embodiment, the shape and structure of the cutting element 20 may be selected according to an actual case. For example, the shape may be a regular shape such as a circular shape or a triangular shape or an irregular shape, or a metal element such as a metal wire or a nonmetal element may be used.

In summary, in the cutting assembly and the lawn mower of the embodiments of the present disclosure, the at least two cutting element groups are disposed at the different heights of the cutting deck, to enable the cutting assembly to be driven by the lawn mower to form the at least two cutting trajectories, and the cutting trajectories are distributed at the different heights of the cutting deck, so that long grass is cut repeatedly into smaller pieces.

The technical features in the foregoing embodiments may be randomly combined. For concise description, not all possible combinations of the technical features in the embodiments are described. However, provided that combinations of the technical features do not conflict with each other, the combinations of the technical features are considered as falling within the scope described in this specification.

The above embodiments only express several implementations of the disclosure, which are described specifically and in detail, and therefore cannot be construed as a limitation to the patent scope of the disclosure. It should be noted that, a person of ordinary skill in the art may further make some variations and improvements without departing from the concept of the disclosure, and the variations and improvements belong to the protection scope of the disclosure. Therefore, the protection scope of the patent of the disclosure shall be topic to the claims.

1-12. (canceled)

13. A lawn mower, comprising:
a housing;
a cutting assembly, mounted at the housing, and performing cutting work; and
a driving apparatus, comprising a motor and an output shaft, connected to the cutting assembly, and driving the cutting assembly to perform cutting work, wherein
the cutting assembly comprises a cutting deck and at least two cutting element groups, the cutting deck is connected to the output shaft, cutting element groups of the at least two cutting element groups are respectively located at different heights of the output shaft, and in the height direction of the cutting deck, from the top to the bottom, the diameter of the cutting trajectories of each cutting element group decreases gradually; the cutting deck responds to driving of the driving apparatus to drive the at least two cutting element groups to rotate to form at least two cutting trajectories, and in different cutting trajectories, the distance between the cutting element group and a center point of the output shaft is not equal, a radius difference between the cutting trajectories formed by the two adjacent cutting element groups is less than or equal to 20 mm.

14. The lawn mower according to claim 13, wherein the cutting trajectories are circles, a diameter of the cutting trajectory of the cutting element group located above is greater than a diameter of the cutting trajectory of the cutting element group located below of two adjacent cutting element groups, and the at least two cutting element groups are disposed layer by layer from the top to the bottom in a height direction of the cutting deck.

15. The lawn mower according to claim 13, wherein the cutting elements within each cutting element group are connected with the cutting deck through a fitting structure.

16. The lawn mower according to claim 13, wherein each cutting element group comprises at least two cutting element, and the at least two cutting elements are evenly distributed in the circumferential direction of the cutting deck.

17. The lawn mower according to claim 16, wherein a length by which the cutting element protrudes from the cutting deck is greater than or equal to 8 mm.

18. The lawn mower according to claim 16, wherein the cutting elements within each cutting element group are distributed in a staggered manner in the circumferential direction of the cutting deck.

19. The lawn mower according to claim 13, wherein the phase of each cutting element in one cutting element group is the same as that in the other cutting element group of any two cutting element groups.

20. The lawn mower according to claim 13, wherein a spacing between the adjacent cutting element groups is between 10 mm and 20 mm.

21. The lawn mower according to claim 13, wherein a diameter of the cutting deck is less than or equal to 250 mm.

22. The lawn mower according to claim 13, wherein mounting portions are disposed on the cutting deck, the mounting portions are used to fix the cutting element groups, and the mounting portions are located on an upper surface and a lower surface of the cutting deck.

23. The lawn mower according to claim 13, wherein the mounting portions and the cutting deck are mounted independently.

24. The lawn mower according to claim 22, wherein the cutting element groups are rotatably disposed on the mounting portions by connecting members.

25. The lawn mower according to claim 13, wherein at least one cutting element group comprises at least one cutting element, which is rotationally mounted on the cutting deck.

26. The lawn mower according to claim 25, wherein the cutting blade is a straight blade, and blade edges are disposed on both sides of the blade.

27. A cutting assembly, comprising a cutting deck and at least two cutting element groups, cutting element groups of the at least two cutting element groups are respectively located at different heights of the cutting deck, and in the height direction of the cutting deck, from the top to the bottom, the diameter of the cutting trajectories of each cutting element group decreases gradually; the cutting deck responds to driving of the driving apparatus to drive the at least two cutting element groups to rotate to form at least two cutting trajectories, and in different cutting trajectories, the distance between the cutting element group and a center point of the cutting deck is not equal, a radius difference between the cutting trajectories formed by the two adjacent cutting element groups is less than or equal to 20 mm.

28. A lawn mower, walking and/or working in a working area defined by a boundary, and comprising:
a housing;
a movement apparatus, supporting the housing, and used to drive the lawn mower to move;
a cutting assembly, mounted at the housing, and performing cutting work;
a driving apparatus, comprising a motor and an output shaft, connected to the cutting assembly, and driving the cutting assembly to perform cutting work; and
a control apparatus, electrically connected to the movement apparatus, the cutting assembly, and the driving apparatus, and used to control the driving apparatus to drive the lawn mower to move and/or work automatically, wherein
the cutting assembly comprises a cutting deck and at least two cutting element groups, the cutting deck is connected to the output shaft, cutting element groups of the at least two cutting element groups are respectively located at different heights of the output shaft, and in the height direction of the cutting deck, from the top to the bottom, the diameter of the cutting trajectories of each cutting element group decreases gradually; the cutting deck responds to driving of the driving apparatus to drive the at least two cutting element groups to rotate to form at least two cutting trajectories, and in different cutting trajectories, the distance between the cutting element group and a center point of the output shaft is not equal, a radius difference between the cutting trajectories formed by the two adjacent cutting element groups is less than or equal to 20 mm.
